(19) United States
(12) Patent Application Publication
(10) Pub. No.: US 2025/0091823 A1
(43) Pub. Date: Mar. 20, 2025

(54) CARGO LOADING GUIDANCE SYSTEM

(71) Applicant: Isuzu Motors Limited, Yokohama-shi (JP)

(72) Inventors: Maya MATSUSHITA, Fujisawa-shi (JP); Tomoaki SHIMOZAWA, Fujisawa-shi (JP); Yuka MIZUSHI, Fujisawa-shi (JP); Atsushi SHITANAKA, Fujisawa-shi (JP)

(73) Assignee: Isuzu Motors Limited, Yokohama-shi (JP)

(21) Appl. No.: 18/888,202

(22) Filed: Sep. 18, 2024

(30) Foreign Application Priority Data
Sep. 19, 2023 (JP) 2023-150900

(51) Int. Cl. B65G 67/04; B65G 43/08

(52) U.S. Cl. CPC B65G 67/04; B65G 43/08

(57) ABSTRACT

Provided is a cargo loading guidance system that guides loading of a cargo in a cargo compartment and includes: a depth sensor that is installed in the cargo compartment and measures depth data of the cargo compartment; a cargo compartment state estimation section that estimates a cargo compartment state from the measured depth data; a specification section that specifies a placing location of the cargo in the cargo compartment by referring to a size of the cargo, based on the estimated cargo compartment state; and a guidance apparatus that is installed inside the cargo compartment and indicates the placing location specified by the specification section.

### CROSS REFERENCE TO RELATED APPLICATIONS

This application is a Paris Convention, which claims the benefit of priority of Japanese Patent Application No. 2023-150900 filed on Sep. 19, 2023. The contents of the above application is all incorporated by reference as if fully set forth herein in its entirety.

### TECHNICAL FIELD

The present disclosure relates to a cargo loading guidance system.

### BACKGROUND ART

When a cargo is loaded onto a vehicle platform, the position in which the cargo is loaded is generally determined by confirming the size of the cargo and the state in the cargo compartment, and by considering the delivery order and an available space in the cargo compartment.

Such determination of the loading position utilizes a transportation system or the know-how of a skilled worker. Further, in a case where a cargo placed in the cargo compartment is unloaded, the position of the placing location of the cargo is acquired from a transportation system or the memory of a worker.

For example, Patent Literature (hereinafter referred to as “PTL”) 1 discloses a system including: a cargo sensor that is attached to a cargo compartment provided in a vehicle; a detection section that detects an available space that is a space in which a cargo can be loaded based on an output signal of the cargo sensor; a determination section that determines whether a cargo can be loaded in the available space based on the size of the cargo; and an output section that outputs a determination result.

Further, for example, PTL 2 discloses a system that assists in loading automation, and includes: a depth sensor disposed on a lateral side of a mobile body; a cargo detection section that detects a predetermined surface of a cargo based on lateral side data of the depth sensor; a jig detection section that specifies a predetermined surface of a jig based on data of the predetermined surface of the cargo and detects the predetermined surface of the jig by using specified data; and a distance calculation section that calculates a distance between the predetermined surface of the cargo and the predetermined surface of the jig. Further, PTL 2 discloses that the calculated distance is transmitted to a transport system, and various controls, such as control of a crane installed in a factory, which are necessary when a cargo is loaded onto a platform, are executed by using the distance transmitted by the transport system.

### CITATION LIST

### Patent Literature

### PTL 1

Japanese Patent Application Laid-Open No. 2021-42028

### PTL 2

Japanese Patent Application Laid-Open No. 2023-36125

### SUMMARY OF INVENTION

### Technical Problem

Incidentally, in a case where a transportation system is utilized when the loading position of a cargo is determined, the worker needs to confirm the loading position determined by the system or the position of the cargo with a terminal at hand or the like, and the workability may decrease.

Further, in a case where the know-how or memory of a skilled worker is utilized, individual differences may arise in work efficiency.

Further, the system described in PTL 1 needs to confirm the loading position of a cargo with a terminal at hand or the like in a case where a determination result of whether the cargo can be loaded is outputted to a user interface, which may decrease the work efficiency in cargo handling work.

Further, the system described in PTL 2 is applicable to a case where a loading work is performed using a cargo handling machine, such as a crane, used for moving a cargo, but it is difficult to apply the system to a case where a loading work is performed by a worker without using a cargo handling machine.

An object of the present disclosure is to provide a cargo loading guidance system capable of enhancing the work efficiency in cargo handling work.

### Solution to Problem

In order to achieve the above object, the cargo loading guidance system according to the present disclosure guides loading of a cargo in a cargo compartment. The cargo loading guidance system includes: a depth sensor that is installed in the cargo compartment and measures depth data of the cargo compartment; a cargo compartment state estimation section that estimates a cargo compartment state from the measured depth data; a specification section that specifies a placing location of the cargo in the cargo compartment by referring to a size of the cargo, based on the estimated cargo compartment state; and a guidance apparatus that is installed inside the cargo compartment and indicates the placing location specified by the specification section.

### Advantageous Effects of Invention

According to the present disclosure, it is possible to enhance the work efficiency in cargo handling work.

### BRIEF DESCRIPTION OF DRAWINGS

FIG. 1 is a functional block diagram functionally illustrating a cargo loading guidance system in an embodiment of the present disclosure;

FIG. 2 schematically illustrates vehicle 1 in which the cargo loading guidance system in the embodiment of the present disclosure is mounted;

FIG. 3 illustrates a guidance apparatus in another embodiment of the present disclosure;

FIG. 4A is a rear view of the vehicle as seen from the rear;

FIG. 4B is a side view of the vehicle as seen from a side; and

FIG. 5 schematically illustrates a depth sensor in further another embodiment of the present disclosure.

### DESCRIPTION OF EMBODIMENTS

Hereinafter, embodiments of the present disclosure will be described with reference to the accompanying drawings.

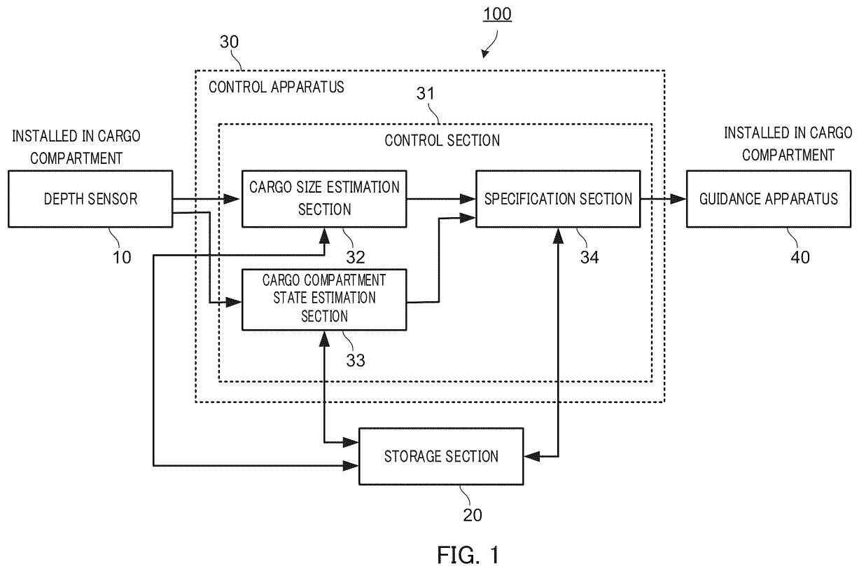

FIG. 1 is a functional block diagram functionally illustrating a cargo loading guidance system in an embodiment of the present disclosure. In FIG. 1, the arrows indicate main data flows, and there may be data flows not illustrated in FIG. 1. In FIG. 1, each functional block represents a configuration in units of functions, not in units of hardware (apparatuses). The functional blocks illustrated in FIG. 1 may therefore be implemented within a single apparatus or distributed across a plurality of apparatuses. The data exchange between the functional blocks may be performed through any means such as a data bus, a communication network, or the like.

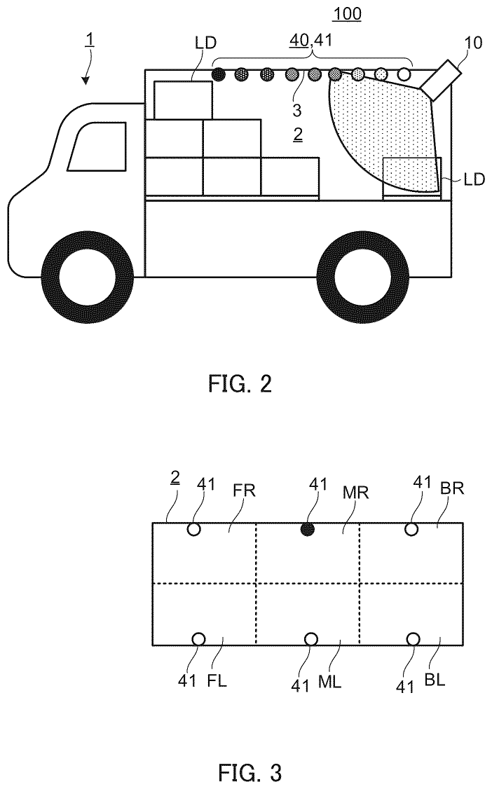

FIG. 2 schematically illustrates vehicle 1 in which cargo loading guidance system 100 in the embodiment of the present disclosure is mounted. Cargo loading guidance system 100 is a system for guiding a worker (a driver in a case where the worker is the driver) such that a cargo is placed at an appropriate location in a cargo compartment of the vehicle. Note that, vehicle 1 is, for example, a delivery vehicle into which delivery items as cargos are loaded, or a freight car into which freight is loaded, but is not limited to these vehicles.

As illustrated in FIG. 1, cargo loading guidance system 100 includes depth sensor 10, storage section 20, control apparatus 30, and guidance apparatus 40.

### (Depth Sensor 10)

Depth sensor 10 is disposed in cargo compartment 2. Depth sensor 10 is disposed, for example, at a vehicle-rear-side end of ceiling 3 of cargo compartment 2. Depth sensor 10 captures an image of the interior of cargo compartment 2 from the position in which depth sensor 10 is disposed. Specifically, when cargo LD is loaded, depth sensor 10 captures an image of cargo LD, which is temporarily placed in a position close to the entrance of cargo compartment 2 (a position at a vehicle-rear-side end part illustrated in FIG. 2), and outputs cargo depth image data, which is data of the captured image, to control apparatus 30. Further, depth sensor 10 captures an image of the cargo compartment state and outputs cargo compartment state depth image data, which is data of the captured image, to control apparatus 30.

In the following description, a space in the internal space of cargo compartment 2, which is restricted as the placing location of cargo LD, will be referred to as a “use-restricted space.” Further, a space that is not restricted as the placing location of cargo LD will be referred to as a “usable space.”

### (Storage Section 20)

Storage section 20 is a storage apparatus such as a ROM (Read Only Memory) that stores a basic input output system (BIOS) or the like that realizes control apparatus 30, a random access memory (RAM) that serves as a work area of control apparatus 30, an operating system (OS), an application program, various information that is referred to at the time of execution of the application program, and a hard disk drive (HDD) or a solid state drive (SSD) in which various maps are stored. Note that, control apparatus 30 is installed in a vehicle and is configured integrally with or separately from one or a plurality of other onboard electronic control unit(s) (ECU(s)) that control(s) equipment or a system(s) installed in the vehicle. On the other hand, control apparatus 30 may be installed outside the vehicle and may be connected to depth sensor 10 and guidance apparatus 40 via a communication network.

### (Control Section 31)

Control section 31 is a processor such as the central processing unit (CPU) or the graphics processing unit (GPU) of control apparatus 30, and functions as cargo size estimation section 32, cargo compartment state estimation section 33, and specification section 34 by executing a program stored in storage section 20. Note that, FIG. 1 illustrates an example where control apparatus 30 is configured as a single apparatus. Control apparatus 30, however, may be realized by, for example, a plurality of processors, or a calculation resource such as a memory. In this case, each component that constitutes control section 31 is realized by at least one processor among the plurality of different processors executing a program.

Cargo size estimation section 32 estimates the size (width, depth, and height) of cargo LD based on cargo depth image data and by using a known method (for example, the method described in Japanese Patent Application Laid-Open No. 2023-37107).

Cargo compartment state estimation section 33 estimates a use-restricted space and a usable space in the internal space of the cargo compartment based on cargo compartment state depth image data and, in the same manner, by using a known method.

Specification section 34 specifies the placing location of cargo LD in the cargo compartment by referring to the size of cargo LD estimated by cargo size estimation section 32, based on a usable space estimated by cargo compartment state estimation section 33. Note that, in a case where the size of cargo LD is known, specification section 34 may specify the placing location of a cargo in the cargo compartment by referring to the known size.

Note that, in a case where the optimal placing location is specified from among a plurality of locations, specification section 34 specifies the placing location, by referring to the know-how of a skilled worker and, when there is a plurality of pieces of know-how, based on the priorities thereof. For example, in the case of a cargo with an early delivery order, specification section 34 specifies, as the placing location of the cargo, a location closer to the entrance rather than a location farther from the entrance. Further, in the case of a higher cargo than usual, specification section 34 specifies, as the placing location of the cargo, a location closer to the inner wall of the cargo compartment rather than a location farther from the inner wall of the cargo compartment.

Storage section 20 stores the placing location of a cargo in the cargo compartment. Further, storage section 20 stores identification information on a cargo to be placed in the placing location in association with the placing location of the cargo.

### (Guidance Apparatus 40)

Guidance apparatus 40 includes a plurality of light-emitting diodes 41. Each of the plurality of light-emitting diodes 41 is disposed on ceiling 3 of cargo compartment 2 such that the plurality of light-emitting diodes 41 is arranged in the vehicle front-rear direction at predetermined intervals.

Guidance apparatus 40 indicates the placing location that is specified by specification section 34 and stored in storage section 20. In the following description, the “placing location” may be referred to as the “location to be guided”. For example, guidance apparatus 40 causes only one or a plurality of light-emitting diodes 41, which corresponds to the placing location (location to be guided), to emit light. Note that, guidance apparatus 40 may indicate a direction from a side of the entrance of cargo compartment 2 toward the placing location. For example, guidance apparatus 40 may cause light-emitting diodes 41 to emit light such that the light flows from the side of the entrance toward a placing location (see FIG. 2). In this case, guidance apparatus 40 causes two or more light-emitting diodes 41 of the plurality of light-emitting diodes 41 to emit light in a predetermined order. Further, guidance apparatus 40 may indicate the direction (the direction from the side of the entrance of cargo compartment 2 toward the placing location) by using sound (for example, an announcement by voice).

### (Guidance Apparatus 40 in Another Embodiment)

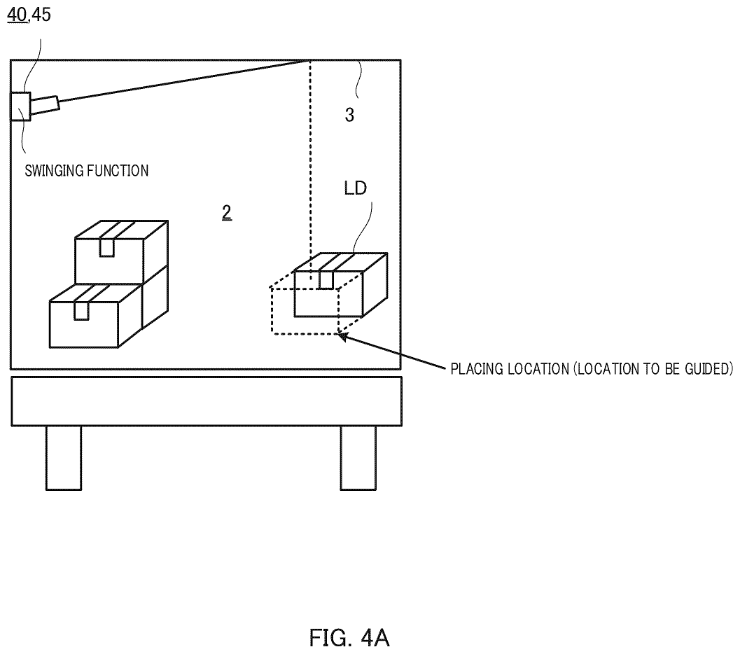

Next, guidance apparatus 40 in another embodiment of the present disclosure will be described with reference to FIG. 3. FIG. 3 illustrates guidance apparatus 40 in another embodiment of the present disclosure. Guidance apparatus 40 illustrated in FIG. 3 includes, for example, six light-emitting diodes 41, and is disposed on inner walls of the cargo compartment. Cargo compartment 2 illustrated in FIG. 3 is divided into, for example, a total of six regions FR, FL, MR, MK, BR, and BL with three regions in the vehicle front-rear direction multiplied by two regions in the vehicle width direction. Six light-emitting diodes 41 are disposed corresponding to six regions FR, FL, MR, MK, BR, and BL, respectively. Then, guidance apparatus 40 causes only one of light-emitting diodes 41, which corresponds to the placing location, to emit light. For example, in a case where the placing location is in region MR, only light-emitting diode 41 corresponding to region MR is caused to emit light (see FIG. 3).

### (Guidance Apparatus 40 in Yet Another Embodiment)

Next, guidance apparatus 40 in yet another embodiment of the present disclosure will be described. On ceiling 3 of cargo compartment 2, a guide rail (not illustrated) that extends in the vehicle front-rear direction is disposed, a slider (not illustrated) that moves along the guide rail is disposed, and further, one or a plurality of light-emitting diodes (not illustrated) is provided in the slider. Guidance apparatus 40 causes the one or plurality of light-emitting diodes to emit light and controls the one or plurality of light-emitting diodes such that the one or plurality of light-emitting diodes moves via the slider from a position at a vehicle-rear-side end part of the guide rail to the front side of the vehicle. Thus, it is possible to indicate the direction from the side of the entrance toward the placing location with one or a small number of light-emitting diodes. Note that, a plurality of light-emitting diodes may be arranged side by side at predetermined intervals from a side of the entrance at ceiling 3 toward the front side of the vehicle, and each of the plurality of light-emitting diodes may be caused to emit light such that light flows from the side of the entrance toward the placing location.

### (Guidance Apparatus 40 in Still Another Embodiment)

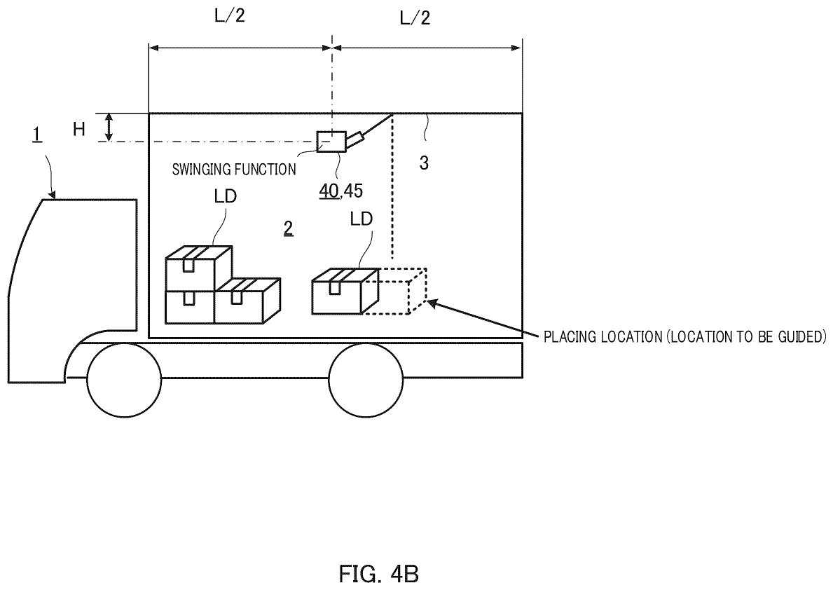

Next, guidance apparatus 40 in still another embodiment of the present disclosure will be described with reference to FIGS. 4A and 4B. FIG. 4A is a rear view of the vehicle as seen from the rear. FIG. 4B is a side view of a vehicle as viewed from a side. FIGS. 4A and 4B indicate the placing location (location to be guided) with a broken line. Guidance apparatus 40 includes laser pointer emission section 45 disposed on an inner wall of the cargo compartment. Further, laser pointer emission section 45 has a swinging function that allows laser pointer emission section 45 emits light to any position on the ceiling. Thus, it is possible to accurately emit light to a position on the ceiling, where the position corresponds to the placing location (location to be guided), and thus, it is possible to guide the worker to the precise placing location and to further enhance the work efficiency in cargo handling work. In addition, it is possible to emit light to the entire range of the ceiling with one laser pointer emission section 45.

Note that, laser pointer emission section 45 is disposed in a central position of the inner wall of the cargo compartment in the vehicle front-rear direction, in other words, in a position in which the distance from the vehicle-front-side end or the-vehicle-rear-side end to the central position in the inner wall of the cargo compartment is a half of total length L of the inner wall of the cargo compartment in the vehicle front-rear direction and which is away from the ceiling by predetermined distance H toward a lower side of the vehicle. Note that, the reason why laser pointer emission section 45 is disposed in the central position is that when the placing location and the pointer are separated, the angle formed by the laser light and the ceiling becomes acute and the pointer is obstructed by a convex-shaped structure (for example, a beam), whereas when the position of the pointer is lowered (H is increased) for avoiding a convex-shaped structure, the pointer is more likely to hit a cargo, and thus, it is satisfactory when the placing location and the pointer are close to each other in order to minimize H, and the central disposition becomes optimal. Further, the reason why laser pointer emission section 45 is disposed in a position away from the ceiling by predetermined distance H toward the lower side of the vehicle is to avoid, in a case where laser pointer emission section 45 is disposed near the ceiling, a situation in which the laser light hits a convex-shaped structure disposed on the ceiling and protruding toward the lower side of the vehicle, and light cannot be emitted to a position to which light should be emitted. Note that, in the above embodiment, laser pointer emission section 45 has been indicated as guidance apparatus 40, but guidance apparatus 40 may be a projector.

The cargo loading guidance system in the embodiments described above is a cargo loading guidance system that guides loading of a cargo in a cargo compartment, and includes: depth sensor 10 that is installed in the cargo compartment and measures depth data of the cargo compartment; cargo compartment state estimation section 33 that estimates a cargo compartment state from the measured depth data; specification section 34 that specifies a placing location of the cargo in the cargo compartment by referring to a size of the cargo, based on the estimated cargo compartment state; and guidance apparatus 40 that is installed inside the cargo compartment and indicates the placing location specified by specification section 34.

With the above configuration, guidance apparatus 40 guides the worker to the placing location, and thus, it is not necessary for the worker to make confirmation with a terminal at hand or the like, and it is possible to enhance the work efficiency in cargo handling work.

Further, in the cargo loading guidance system in the embodiments described above, guidance apparatus 40 indicates a direction from a side of an entrance of the cargo compartment toward the placing location. Thereby, the worker can recognize the direction in which the cargo is moved, and thus, it is possible to enhance the work efficiency in cargo handling work.

Further, in the cargo loading guidance system in the embodiments described above, guidance apparatus 40 indicates the direction from the side of the entrance of the cargo compartment toward the placing location by using light or sound. Since the direction is indicated using light or sound, it is not necessary for the worker to confirm the placing location with a terminal at hand or the like, and it is possible to enhance the work efficiency in cargo handling work.

Further, in the cargo loading guidance system in the embodiments described above, guidance apparatus 40 includes a plurality of light-emitting diodes 41 disposed on the ceiling of the cargo compartment, and guidance apparatus 40 causes two or more light-emitting diodes 41 of the plurality of light-emitting diodes 41 to emit light in a predetermined order such that two or more light-emitting diodes 41 described above indicate the direction from the side of the entrance of the cargo compartment toward the placing location. When light-emitting diodes 41 are disposed on the ceiling, the light delivered from light-emitting diodes 41 to the worker is hardly blocked by a cargo loaded in the cargo compartment, and thus, it is possible to ensure that the worker visually recognizes the direction of the placing location.

Further, the cargo loading guidance system in the embodiments described above further includes cargo size estimation section 32 that estimates the size of the cargo from the measured depth data, and specification section 34 specifies the placing location by referring to the estimated size of the cargo. Thus, even when the side of a cargo is not determined in advance, it is possible to perform a cargo handling work without any trouble, and thus, it is possible to suppress a decrease in the work efficiency in cargo handling work.

Further, in the cargo loading guidance system in the embodiments described above, specification section 34 specifies the placing location of the cargo with an early delivery order such that the placing location of the cargo with the early delivery order is more on a side of an entrance of the cargo compartment than the placing location of the cargo with a late delivery order. Thus, even a beginner in cargo handling work can easily utilize the know-how of a skilled worker.

Note that, in the cargo loading guidance system in the embodiments described above, in a case where the cargo is loaded into the cargo compartment, guidance apparatus 40 indicates the placing location of the cargo in the cargo compartment, but the present disclosure is not limited thereto. In a case where a cargo placed in the cargo compartment is unloaded, guidance apparatus 40 may indicate the placing location of the cargo in the cargo compartment. In this case, for example, control apparatus 30 reads, from storage section 20, the placing location stored in association with the identification information on the cargo, and guidance apparatus 40 indicates the placing location based on the read placing location. Thus, it is possible to assist in a work of loading and unloading a cargo by using one system.

### (Depth Sensor in Further Another Embodiment)

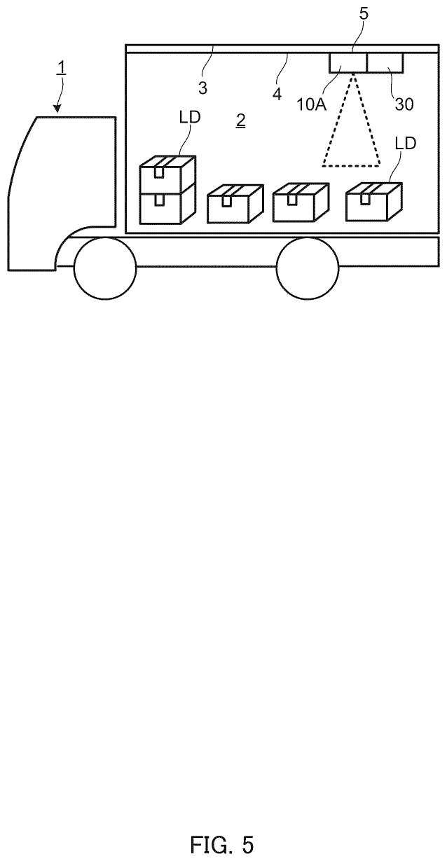

Next, depth sensor 10 in further another embodiment of the present disclosure will be described with reference to FIG. 5. FIG. 5 schematically illustrates depth sensor 10 in further another embodiment. Note that, the guidance apparatus is omitted in the illustration in FIG. 5.

On ceiling 3 of cargo compartment 2, guide rail 4 that extends in the vehicle front-rear direction is disposed, and slider 5 that moves along guide rail 4 is disposed, and further, one stereo camera 10A (depth sensor) and control apparatus 30 are attached to slider 5. Stereo camera 10A captures an image of the interior of the cargo compartment, and outputs cargo depth image data and cargo compartment state depth image data, which are data of the captured image of the interior of the cargo compartment, to control apparatus 30. Thus, it is possible to capture images of the entire range of the interior of the cargo compartment while shifting the position of one stereo camera 10A in the vehicle front-rear direction by a predetermined distance.

Each of the embodiments described above is only illustration of an exemplary embodiment for implementing the present disclosure, and the technical scope of the present disclosure shall not be construed limitedly thereby. That is, the present disclosure can be implemented in various forms without departing from the gist or the main features thereof.

The present disclosure is suitably utilized in a vehicle including a cargo loading system, which is required to enhance the work efficiency in cargo handling work.

1. A cargo loading guidance system that guides loading of a cargo in a cargo compartment, the cargo loading guidance system comprising:
a depth sensor that is installed in the cargo compartment and measures depth data of the cargo compartment;
a cargo compartment state estimation section that estimates a cargo compartment state from the depth data that has been measured;
a specification section that specifies a placing location of the cargo in the cargo compartment by referring to a size of the cargo, based on the cargo compartment state that has been estimated; and
a guidance apparatus that is installed inside the cargo compartment and indicates the placing location specified by the specification section.

2. The cargo loading guidance system according to claim 1, wherein
the guidance apparatus indicates a direction from a side of an entrance of the cargo compartment toward the placing location.

3. The cargo loading guidance system according to claim 2, wherein
the guidance apparatus indicates the direction by using light or sound.

4. The cargo loading guidance system according to claim 3, wherein:
the guidance apparatus includes a plurality of light-emitting diodes disposed on a ceiling of the cargo compartment, and
the guidance apparatus causes two or more light-emitting diodes of the plurality of light-emitting diodes to emit light in a predetermined order such that the two or more light-emitting diodes indicate the direction.

5. The cargo loading guidance system according to claim 3, further comprising a guide rail, a slider, and one or a plurality of light-emitting diodes, the guide rail being disposed on a ceiling of the cargo compartment, the slider moving along the guide rail, the one or plurality of light-emitting diodes being provided in the slider, wherein
the guidance apparatus causes the one or plurality of light-emitting diodes to emit light such that the one or plurality of light-emitting diodes indicates the direction, and the guidance apparatus controls the slider such that the slider moves along the guide rail.

6. The cargo loading guidance system according to claim 1, wherein
the guidance apparatus includes a laser pointer emission section that emits laser pointer light in a direction of a position on a ceiling of the cargo compartment, the position corresponding to a position of the placing location.

7. The cargo loading guidance system according to claim 1, wherein
in a case where the cargo placed in the cargo compartment is unloaded, the guidance apparatus indicates the placing location of the cargo in the cargo compartment.

8. The cargo loading guidance system according to claim 1, further comprising a cargo size estimation section that estimates the size of the cargo from the depth data that has been measured, wherein
the specification section specifies the placing location by referring to the size of the cargo, the size having been estimated.

9. The cargo loading guidance system according to claim 1, wherein
the specification section specifies the placing location of the cargo with an early delivery order such that the placing location of the cargo with the early delivery order is more on a side of an entrance of the cargo compartment than the placing location of the cargo with a late delivery order.
